(19) United States
(12) Patent Application Publication
(10) Pub. No.: US 2011/0111325 A1
(43) Pub. Date: May 12, 2011

(54) FUEL CELL DEVICE INCLUDING A POROUS COOLING PLATE ASSEMBLY HAVING A BARRIER LAYER

(76) Inventor: Tommy Skiba, East Hartford, CT (US)

(21) Appl. No.: 13/002,698

(22) PCT Filed: Aug. 29, 2008
(86) PCT No.: PCT/US08/74710

§ 371 Date: Jan. 5, 2011

(51) Int. Cl. H01M 8/04

(52) U.S. Cl. 429/514

(57) ABSTRACT

An exemplary fuel cell device includes porous plates. Electrode assemblies (24) are adjacent the porous plates (22). Partially porous plates (26) are adjacent the electrode assemblies (24) on an opposite side from the porous plates (22). The porous plates have coolant channels (32) that are configured to carry a liquid coolant. The partially porous plates have flow field channels (40) on one side that are configured to permit a fluid in the flow field channels to contact the corresponding immediately adjacent electrode assembly (24). An opposite side of the partially porous plates have a non-porous surface (42) that is configured to isolate the partially porous plate from any liquid in the coolant channels (32) of an adjacent one of the porous plates (22). Any liquid in the partially porous plate is exclusively from a reaction at the corresponding immediately adjacent electrode assembly.

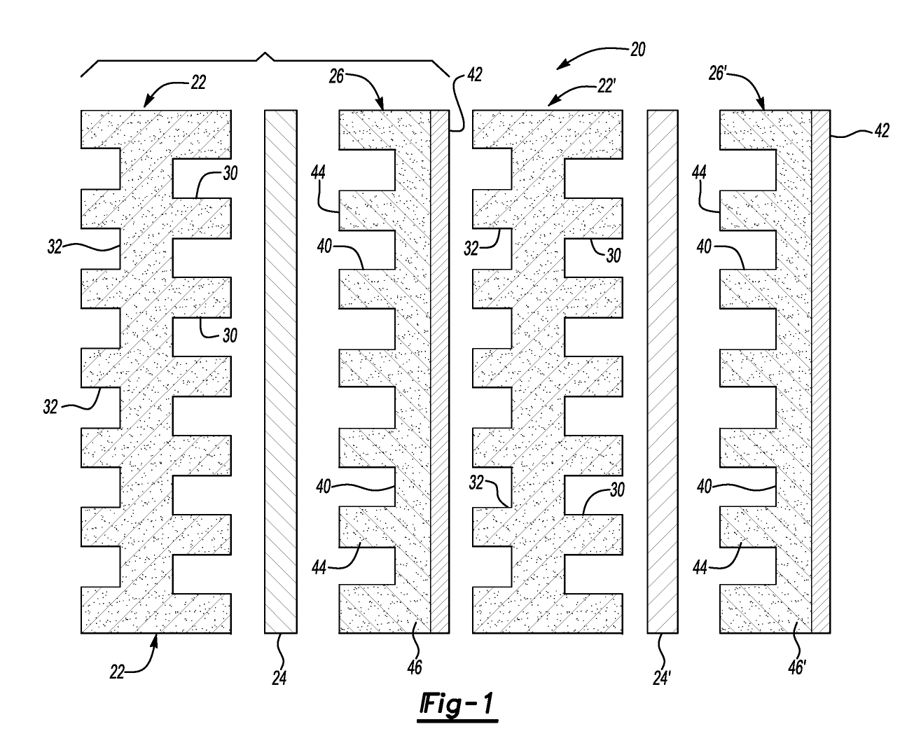

### BACKGROUND

Fuel cell devices are useful for generating electrical power based upon an electrochemical reaction. A variety of fuel cell devices are known. Each of them has different features that may be advantageous or a drawback.

For example, solid plate fuel cells do not require as much water in a cell stack assembly as porous plate fuel cells do. On the other hand, the porous plate fuel cells provide great durability. The additional water in a porous plate fuel cell arrangement can pose a problem in some conditions such as low temperatures where a start up is required and some or all of the water has frozen in locations that interfere with the desired reaction needed to generate power.

One proposed solution is to use a hybrid cell that has a porous plate on one side of an electrode assembly and a solid plate on the other side. Such arrangements can be used with the known evaporative cooling operating mode. This proposal can reduce the water volume but still is susceptible to problems during frozen starts as water can be frozen in the fuel flow field channels and substrates, themselves.

There is a need for an improved arrangement that takes advantage of the benefits of a porous plate fuel cell arrangement and reduces the potential for problems during a frozen start, for example.

### SUMMARY

An exemplary fuel cell device includes a first completely porous plate. A first electrode assembly is immediately adjacent the first completely porous plate. A first partially porous plate is immediately adjacent the first electrode assembly on an opposite side from the first completely porous plate. A second completely porous plate is immediately adjacent the first partially porous plate on an opposite side from the first electrode assembly. A second electrode assembly is immediately adjacent to the second completely porous plate on an opposite side from the first partially porous plate. A second partially porous plate is immediately adjacent the second electrode assembly on an opposite side from the second completely porous plate.

The completely porous plates have flow field channels on one side that are configured to permit a fluid in the flow field channels to contact the immediately adjacent electrode assembly. An opposite side of the completely porous plates has coolant channels that are configured to carry a liquid coolant. The partially porous plates have flow field channels on one side that are configured to permit a fluid in the flow field channels to contact the corresponding immediately adjacent electrode assembly. An opposite side of the partially porous plates have a non-porous surface that is configured to isolate the partially porous plate from any liquid in the coolant channels of an adjacent one of the completely porous plates. Any liquid in the partially porous plate is exclusively from a reaction at the corresponding immediately adjacent electrode assembly.

An exemplary method of managing fluid distribution in a fuel cell includes introducing fuel into the flow field channels of the completely porous plates and the flow field channels of the partially porous plates such that an electrochemical reaction occurs at the electrode assemblies. A liquid coolant is introduced into the coolant channels of the completely porous plates. The partially porous plate is isolated from liquid in the coolant channels using the non-porous layer such that the only liquid in the partially porous plates is exclusively from the electrochemical reaction at a corresponding one of the electrode assemblies.

The various features and advantages of the disclosed example will become apparent to those skilled in the art from the following detailed description. The drawing that accompanies the detailed description can be briefly described as follows.

### BRIEF DESCRIPTION OF THE DRAWING

The FIGURE schematically illustrates selected portions of a fuel cell device designed according to an embodiment of this invention.

### DETAILED DESCRIPTION

The FIGURE schematically shows selected portions of a fuel cell device 20 that is useful for generating electrical power. A first porous plate 22 is immediately adjacent an electrode assembly 24. As known, the electrode assembly 24 includes a membrane and electrode layers (i.e., an anode catalyst layer and a cathode catalyst layer at opposite sides of the membrane). A partially porous plate 26 is immediately adjacent the electrode assembly 24 on an opposite side of the assembly from the porous plate 22. The electrode assembly 24 combined with the porous plate 22 and the partially porous plate 26 establishes a single cell within a cell stack assembly.

In the illustrated example, the porous plates 22 are on an anode side of each cell and the partially porous plates 26 are on the cathode side of each cell.

A second porous plate 22′ is immediately adjacent the first partially porous plate 26. A second electrode assembly 24′ is immediately adjacent the second porous plate 22′ on an opposite side from the first partially porous plate 26. A second partially porous plate 26′ is immediately adjacent the second electrode assembly 24′ as schematically shown.

Each of the porous plates includes a plurality of flow field channels 30 on a side facing the corresponding immediately adjacent electrode assembly 24. The flow field channels 30 are configured to allow a fluid to contact the electrode assembly for purposes of allowing the electrochemical reaction to occur for generating electrical power.

An opposite side of the porous plates 22 includes a plurality of coolant channels 32 that are configured to carry a liquid coolant to provide cooling during fuel cell operation, for example.

In one example, the porous plates 22 are completely porous. In another example, the porous plates 22 are porous at least on the side including the flow field channels 30 and solid or non-porous on the side including the coolant channels 32. In one example, the porous plates 22 comprise a single-piece structure.

In another example two separate layers are preformed and then joined together (back-to-back) to establish the two sides of the porous plates 22. In one example the coolant channels 32 are part of one piece and the flow field channels 30 are part of a separately formed piece.

Each partially porous plate 26 includes a plurality of flow fields 40 on a side that faces a corresponding immediately adjacent electrode assembly 24. The flow field channels 40 are configured to allow a fluid to contact the electrode assembly for facilitating the electrochemical reaction. For example, gases such as hydrogen and air are introduced into the flow field channels 30 and 40 and the electrochemical reaction occurs at the electrode assembly 24.

An opposite side of the partially porous plate 26 has a non-porous surface 42 that isolates the partially porous plate 26 from any liquid coolant in the coolant channels 32. With such an arrangement, any liquid in the partially porous plate 26 is exclusively from the reaction at the electrode assembly 24 immediately adjacent the corresponding flow field channels 40. For example, when air and hydrogen are introduced into the flow field channels 30 and 40, water may be a byproduct of the electrochemical reaction at the electrode assembly 24. Such liquid water can be absorbed into the porous portion of the partially porous plates 26. In the illustrated example, a plurality of ribs 44 and a porous body portion 46 are each capable of absorbing the liquid water byproduct from the electrochemical reaction at the electrode assembly 24. With such an arrangement, the only liquid within the partially porous plates 26 is from the reaction at the electrode assembly 24.

The liquid coolant in the channels 32 is only connected to one-half of each cell by being isolated to the porous plates 22. Having liquid water exclusively from the electrochemical reaction within the partially porous plates 26 allows the partially porous plates 26 to function as a solid plate during fuel cell operation while providing the additional, beneficial feature of providing a reservoir for liquid water. The reservoir of the partially porous plate 26 provides a location for storing excess water in the fuel cell in a manner that it can freeze under low temperature conditions without blocking off the flow field channels and preventing reactants from reaching the electrode assemblies 24.

One feature of the illustrated example is that the porous plates 22 will be completely filled with liquid because of the presence of the liquid coolant in the channels 32 and by-product water in the flow field channels 30. The partially porous plates 26, on the other hand, will always be less than completely filled with liquid. In other words, there is no operative condition of the example fuel cell assembly 20 in which the partially porous plates 26 are completely filled with water. Keeping the partially porous plates 26 only partially filled helps to ensure that any freezing water will not interfere with a start of the fuel cell device under low temperature conditions.

In one example, the partially porous plates 26 comprise a first material for the porous portion such as the ribs 44 and the body 46 and another, different material for the non-porous surface 42. In one example, the porous material comprises carbon.

One example includes spray coating or otherwise treating the surface 42 to make it non-porous. Applying an appropriate material to the surface 42 can fill the porosity that otherwise would exist on that surface to seal off that side of the partially porous plate 26 in a manner that will isolate the porous portion from any coolant in the coolant channels 32.

Another example includes using the same material for the entire partially porous plates 26. The molding process is controlled, for example, to achieve a first porosity at the ribs 44 and body portion 46 and a second, lower porosity along the surface 42 such that the surface 42 is operationally non-porous.

Another example includes establishing the non-porous surface 42 by securing a solid plate to the porous portion of the partially porous plate 26.

The illustrated example provides a reservoir for water that is useful during frozen start conditions, for example. Because the partially porous plate 26 is at least partially porous, the thermal mass is reduced. Using the partially porous plates 26 is also useful for normal start up conditions before the stack reaches an evaporative cooling temperature. The illustrated example is useful for evaporative cooling approaches for fuel cell control and provides a useful technique for controlling water distribution in a fuel cell assembly.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A fuel cell device, comprising:
an electrode assembly;
a partially porous plate adjacent the electrode assembly;
a porous plate adjacent the partially porous plate on an opposite side of the partially porous plate from the electrode assembly, the porous plate having flow field channels on one side that are configured to permit a fluid in the flow field channels to contact a second electrode assembly on an opposite side of the porous plate, the porous plate having coolant channels that are configured to carry a liquid coolant on a side of the porous plate facing the partially porous plate;
the partially porous plate having flow field channels on one side that are configured to permit a fluid in the flow field channels to contact the electrode assembly, an opposite side of the partially porous plates having a non-porous surface that is configured to isolate the partially porous plates from any liquid in the coolant channels of the porous plate such that any liquid in the partially porous plate is exclusively from a reaction at the electrode assembly.

2. The fuel cell device of claim 1, wherein the partially porous plate includes a porous body comprising a first material and the non-porous surface comprises a second, different material.

3. The fuel cell device of claim 2, wherein the first material comprises carbon.

4. The fuel cell device of claim 1, wherein the partially porous plate comprises a single material including a first porosity for a porous body portion and a second, relatively lower porosity at the non-porous surface.

5. The fuel cell device of claim 1, wherein the non-porous surface comprises a layer secured to the opposite side of the partially porous plate.

6. The fuel cell device of claim 5, wherein the non-porous surface is sprayed onto the opposite side.

7. The fuel cell device of claim 5, wherein the layer comprises a solid plate.

8. The fuel cell device of claim 1, wherein the partially porous plate provides a functionality of a completely solid plate during operation of the fuel cell device and provides a reservoir for the liquid exclusively from the reaction during another condition of the fuel cell device.

9. The fuel cell device of claim 1, wherein a porous portion of the partially porous plate is only partially filled with liquid and the porous plates are completely filled with liquid during at least one operating condition of the fuel cell device.

10. The fuel cell device of claim 1, wherein the porous plate is on an anode side of the second electrode assembly and the partially porous plate is on a cathode side of the adjacent electrode assembly.

11. A method of managing fluid distribution in a fuel cell including
a porous plate having flow field channels on one side that are configured to permit a fluid in the flow field channels to contact an adjacent electrode assembly, an opposite side of the porous plate having coolant channels; and
a partially porous plate having flow field channels on one side that are configured to permit a fluid in the flow field channels to contact an adjacent electrode assembly, an opposite side of the partially porous plate having a non-porous surface adjacent the coolant channels of the porous plate, the method comprising the steps of:
introducing fuel into the flow field channels of the porous plate and the flow field channels of the partially porous plate such that an electrochemical reaction occurs at the electrode assembly;
introducing a liquid coolant into the coolant channels; and
isolating the partially porous plate from the liquid in the coolant channels using the non-porous layer such that the only liquid in the partially porous plate is exclusively from the electrochemical reaction at the adjacent electrode assembly.

12. The method of claim 11, comprising:
completely filling the porous plate with liquid during at least one operative condition of the fuel cell device; and
only partially filing the partially porous plate with liquid during any operative condition of the fuel cell device.

13. The method of claim 11, comprising:
using the partially porous plate as a functional equivalent of a solid, non-porous plate during the electrochemical reaction; and
using a porous portion of the partially porous plate as a reservoir for the liquid from the electrochemical reaction during at least one operative condition of the fuel cell device.

14. The method of claim 11, wherein each partially porous plate includes a porous body comprising a first material and the non-porous surface comprises a second, different material.

15. The method of claim 14, wherein the first material comprises carbon.

16. The method of claim 11, wherein each partially porous plate comprises a single material including a first porosity for a porous body portion and a second, relatively lower porosity at the non-porous surface.

17. The method of claim 11, wherein each non-porous surface comprises a layer secured to the opposite side of the partially porous plate.

18. The method of claim 17, wherein the non-porous surface is sprayed onto the opposite side.

19. The method of claim 17, wherein the layer comprises a solid plate.

20. The method of claim 11, comprising
exposing only the portions of the fuel cell device comprising the porous plates to the liquid in the coolant channels.
